(19) United States
(12) Patent Application Publication
(10) Pub. No.: US 2010/0077484 A1
(43) Pub. Date: Mar. 25, 2010

(54) LOCATION TRACKING PERMISSIONS AND PRIVACY

(75) Inventors: Christopher Paretti, San Francisco, CA (US); Ori Zaltzman, Mountain View, CA (US); Joseph O'Sullivan, Oakland, CA (US); Kristijan Mihalic, San Francisco, CA (US); Marc E. Davis, San Francisco, CA (US); Christopher W. Higgins, Portland, OR (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/236,037

(22) Filed: Sep. 23, 2008

(51) Int. Cl. G06F 21/00; G06F 17/30

(52) U.S. Cl. 726/26; 726/1

(57) ABSTRACT

A location tracking privacy engine is described herein that is configured to allow users to define privacy policies that govern how location information about each user is provided to context-aware applications and services. Privacy policies can be defined in a highly flexible and context-specific manner such that the execution of a given privacy policy by the location tracking privacy engine is dependent on the existence of one or more social, topical, temporal or spatial conditions. Privacy policies are then executed automatically by the location tracking privacy engine when the conditions associated with the policies are determined to be satisfied.

### BACKGROUND OF THE INVENTION

1. Field of the Invention

The present invention generally relates to systems that automatically track the location of users. More specifically, the present invention relates to means for enabling users to control the manner in which such systems obtain, disseminate and/or report user location information.

2. Background

Numerous systems and methods exist for automatically tracking the location of users. Such tracking may be performed to support context-aware applications, to provide location-based services, or for a variety of other reasons. Tracking of users is often performed by tracking the location of a device or object uniquely associated with the user. For example, numerous mobile devices carried by users today include technology that enables the location of such devices to be determined with varying degrees of accuracy. Such technology may include but is not limited to Global Positioning System (GPS) technology, Wi-Fi technology, cellular telephony technology and Bluetooth™ technology.

Information obtained from such devices may include actual location information, such as when the device has built-in GPS capability, or relative location information, such as proximity to other mobile devices, beacons, or other identifiable objects or locations. U.S. patent application Ser. No. 12/028,422 to Davis et al., filed Feb. 8, 2008, describes a system that is capable of establishing a proximity-based ad hoc network among a plurality of mobile devices by leveraging actual and relative location information obtained from such devices. The proximity-based ad hoc network may then be used to track the locations of users associated with the devices. However, this is only one example of a location tracking system and numerous other location tracking systems exist in the art.

The location of a user may also be determined in many other ways beyond tracking the location of a device or object associated with a user. For example, recorded information concerning a commercial transaction carried out by a user may place the user at a particular commercial establishment at a particular time. As another example, when a user performs an activity on a networked computer having an IP address, location information associated with the IP address may be used to locate the user. A user may also actively enter data (e.g., a zip code) into a networked computer or other device from which the location of the user may be inferred. These are only a few examples, and numerous other methods for tracking the location of a user are known.

Given that many methods exist for tracking the location of a user, a user may be rightfully concerned about how information about his/her location is being tracked, the nature of such information, and to whom such information is being reported. Unanticipated or unauthorized location tracking and reporting may justifiably give rise to fundamental concerns about user privacy and security. Users may not want certain entities or persons to know where they currently are, where they have been in the past, or where they are likely to be in the future for any number of reasons.

Users who are concerned about location tracking may choose to divest themselves of technology that is capable of being used to track their location. However, by so doing, such users will then lose the benefits of that technology, including the benefits of applications and services premised on location tracking. Additionally, by divesting themselves of such technology, such users may deprive systems that leverage location information obtained from a plurality of users (such as the system described in the aforementioned U.S. patent application Ser. No. 12/028,422 to Davis et al.) of valuable information.

What is needed then is a system and method for enabling a user to control the manner in which location information associated with the user is obtained, disseminated and/or reported by a location tracking system.

### BRIEF SUMMARY OF THE INVENTION

A system and method is described herein that allows users to define privacy policies that govern how location information about each user is provided to context-aware applications and services. Privacy policies can be defined in a highly flexible and context-specific manner such that the execution of a given privacy policy by the system is dependent on the existence of one or more social, topical, temporal or spatial conditions. Privacy policies are then executed automatically by the system when the conditions associated with the policies are determined to be satisfied.

In particular, a method is described herein for permitting a user to control the manner in which location information associated with the user is provided to one or more applications or services. In accordance with the method, a location tracking privacy policy associated with the user is obtained, wherein the location tracking privacy policy includes a location reporting methodology and one or more enforcement conditions. Location information associated with the user is then obtained. A determination is made as to whether the enforcement condition(s) have been satisfied. Responsive to determining that the enforcement condition(s) have been satisfied, the manner in which the location information associated with the user is provided to at least one application or service is controlled in accordance with the location reporting methodology responsive to determining that the enforcement condition(s) have been satisfied.

In accordance with the foregoing method, controlling the manner in which the location information associated with the user is provided to the at least one application or service in accordance with the location reporting methodology may include prohibiting the location information associated with the user from being provided to the at least one application or service, modifying the location information associated with the user, or altering a granularity of the location information associated with the user.

In further accordance with the foregoing method, determining whether the enforcement condition(s) have been satisfied may include determining whether a particular person or category of persons is intended to receive the location information associated with the user, determining whether the user is engaging in an activity associated with a particular topic, determining whether a topical nexus exists between the user and an intended recipient of the location information about the user, determining whether a current time matches a specified time or is within a specified time period, or determining whether a location of the user matches a particular location or is within a particular area.

A system is also described herein. The system includes a user interface, a location tracking system interface and a visibility manager. The user interface is configured to obtain a location tracking privacy policy associated with a user, wherein the location tracking privacy policy includes a location reporting methodology and one or more enforcement conditions. The location tracking system interface is configured to obtain location information associated with the user. The visibility manager is configured to determine whether the enforcement condition(s) have been satisfied and to control the manner in which the location information associated with the user is provided to at least one application or service in accordance with the location reporting methodology responsive to determining that the enforcement condition(s) have been satisfied.

The visibility manager may be configured to control the manner in which the location information associated with the user is provided to the at least one application or service in accordance with the location reporting methodology by prohibiting the location information associated with the user from being provided to the at least one application or service, by modifying the location information associated with the user, or by altering a granularity of the location information associated with the user.

The visibility manager may also be configured to determine whether the enforcement condition(s) have been satisfied by determining whether a particular person or category of persons is intended to receive the location information associated with the user, by determining whether the user is engaging in an activity associated with a particular topic, by determining whether a topical nexus exists between the user and an intended recipient of the location information about the user, by determining whether a current time matches a specified time or is within a specified time period, or by determining whether a location of the user matches a particular location or is within a particular area.

A method is also described herein for enabling a user to modify logged location information associated with the user. In accordance with the method, a first request is received to access location information associated with the user that is stored in one or more location information logs. Responsive to receiving the first request, access is provided to the location information associated with the user. A second request is then received to modify the location information associated with the user. Responsive to receiving the second request, the location information associated with the user is modified responsive to receiving the second request. Modifying the location information associated with the user may include deleting the location information associated with the user or changing the content of the location information.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a system in accordance with an embodiment of the present invention that enables a user to control the manner in which location information associated with the user is obtained, disseminated and/or reported.

FIG. 2 is a block diagram of a location tracking privacy engine in accordance with an embodiment of the present invention.

FIG. 3 illustrates different types of user data that may be used to specify, enforce and recommend location tracking privacy policies in accordance with an embodiment of the present invention.

FIG. 4 depicts a flowchart of a method for enabling a user to control the manner in which location information associated with the user is provided to an application or service in accordance with an embodiment of the present invention.

FIG. 5 is a block diagram of a system in accordance with an embodiment of the present invention that enables a user to modify logged location information associated with the user.

FIG. 6 depicts a flowchart of a method for enabling a user to modify logged location information associated with the user in accordance with an embodiment of the present invention.

FIG. 7 is a block diagram of a location tracking privacy engine that controls the reporting of location information collected from devices/objects associated with a user and devices/objects not associated with the user based on a privacy policy enacted by the user in accordance with an embodiment of the present invention.

FIG. 8 depicts a flowchart of a method for controlling the reporting of location information collected from devices/objects associated with a user and devices/objects not associated with the user based on a privacy policy enacted by the user in accordance with an embodiment of the present invention.

FIG. 9 is a block diagram of a location tracking privacy engine in accordance with an embodiment of the present invention that is configured to receive and analyze location information about a user from two or more location tracking systems to ensure that there is no direct or derived disclosure of user location in violation of a user privacy policy.

FIG. 10 depicts a flowchart of a method by which a location tracking privacy engine automatically recommends a location tracking privacy policy to a user in accordance with an embodiment of the present invention.

FIG. 11 depicts a flowchart of a method by which a location tracking privacy engine automatically enacts a location tracking privacy policy on behalf of a user in accordance with an embodiment of the present invention.

FIG. 12 is a block diagram of a location tracking privacy engine in accordance with an embodiment of the present invention that may be implemented on a user device.

FIG. 13 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example System Architecture

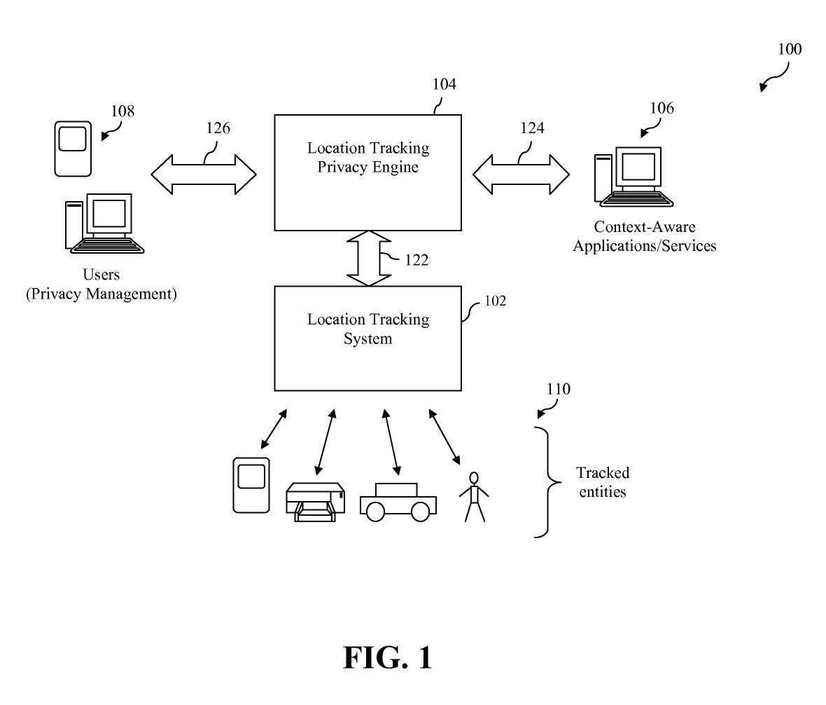

FIG. 1 is a high-level block diagram of an exemplary system 100 for enabling a user to control the manner in which location information associated with the user is obtained, disseminated and/or reported. As shown in FIG. 1, system 100 includes a location tracking system 102 and a location tracking privacy engine 104 that is communicatively connected thereto via a first interface 122. As further shown in FIG. 1, location tracking privacy engine 104 is communicatively connected to context-aware applications/services 106 via a second interface 124 and to users 108 via a third interface 126. Each of the elements of system 100 will now be briefly described, with additional details to be provided in subsequent sections.

Location tracking system 102 is intended to broadly represent any system capable of automatically tracking the location of certain entities. Generally speaking, location tracking system 102 is configured to obtain location information about a plurality of tracked entities 110, wherein such location information may be indicative of a current, past or future location of each of tracked entities 110. The location information may include actual location information, such as a geographical identifier of a location of an entity (including but not limited to longitude/latitude coordinates, street address, city name, zip code, or the like) or relative location information, such as proximity to certain identifiable entities including but not limited to other tracked entities. Depending upon the implementation, location tracking system 102 may be premised on any of a variety of well-known technologies for producing such location information, including but not limited to Global Positioning System (GPS) technology, Wi-Fi technology, cellular telephony technology and/or Bluetooth™ technology. For example, mobile devices that incorporate such technology may provide information to location tracking system 102 that can be used to track the location of such mobile devices with varying degrees of accuracy. However, this example is not intended to be limiting, and location tracking system 102 may utilize other methods for tracking the location of tracked entities 110.

In one embodiment, location tracking system 102 comprises a system that is capable of establishing a proximity-based ad hoc network among a plurality of sensor-enabled devices by leveraging actual and relative location information obtained from such devices, such as the system described in U.S. patent application Ser. No. 12/028,422 to Davis et al., filed Feb. 8, 2008, the entirety of which is incorporated by reference as if fully set forth herein. As described in that application, a proximity-based ad hoc network so established may be used to track the locations of users associated with the sensor-enabled devices.

Tracked entities 110 are intended to broadly represent any entities that are capable of being tracked by a location tracking system. Such entities include, but are not limited to people, animals, mobile user devices (e.g., mobile telephones, personal digital assistants, laptop and handheld computers, media players, handheld navigation devices, handheld scanners), vehicles (e.g., automobiles, airplanes, trucks, trains), office equipment (e.g., computers, printers, copiers), appliances, inventory, freight, parcels, or commercial products, to name only a few.

Location tracking privacy engine 104 is configured to act as an intermediary between location tracking system 102 and certain context-aware applications and services that consume location information. In particular, location tracking privacy engine 104 is configured to obtain location information about tracked entities 110 from location tracking system 102 and to provide such information to context-aware applications and services 106. Location tracking privacy engine 104 is further configured to control the manner in which such location information is provided to context-aware applications/services 106. As will be discussed in more detail herein, controlling the manner in which such location information is provided to context-aware applications/services 106 may include providing the location information, not providing the location information, modifying the content or granularity of the location information, selectively providing the location information to certain applications/services or users thereof, and/or selectively modifying the content or granularity of the location information based on a recipient application/service or user thereof. Location tracking privacy engine 104 performs this function in accordance with privacy policies set by users associated with the tracked entities.

Context-aware applications/services 106 are intended to represent any application or service capable of consuming location information associated with a tracked entity and using such information to execute a function or perform a service on behalf of a user. Applications encompassed by context-aware applications/services 106 may include, for example, mobile communication or social networking applications that report location information about a user or a device associated with a user to other users, wherein such location information may include actual location information about the user/device or relative location information about the user/device (e.g., information indicating that a user/device is proximal to other users/devices). Such applications may include, for example, applications encompassed by or designed to operate in conjunction with the oneConnect™ mobile communication technology platform developed and commercialized by Yahoo! Inc. of Sunnyvale, Calif.

Services encompassed by context-aware applications/services 106 may include any location-based or location-aware service including but not limited to personal navigation services, resource location services (e.g., providing an identification of a local business, professional, or service, such as an ATM, doctor or restaurant, responsive to a user query), resource tracking services (e.g., tracking of objects such as packages and train boxcars), resource tracking services with dynamic distribution (e.g., fleet scheduling and tracking of taxis, service people, rental equipment, doctors, etc.), proximity-based notification services (e.g., alerts or notices, such as notification of a sale on gas, warning of a traffic jam, or co-presence of an actual or potential business or social contact), location-based content delivery services (e.g., local weather, targeted advertising or coupons), location-based billing services (e.g., EZ pass and toll watch), and emergency services.

In one embodiment, first interface 122 comprises an application programming interface (API) that can be used to build applications or processes by which a location tracking system can interact with location tracking privacy engine 104 and second interface 124 comprises an API that can be used to build applications or processes by which a context-aware application/service can interact with location tracking privacy engine 104, although the invention is not so limited.

Third interface 126 is configured to allow users 108 to interact with location tracking privacy engine 104 for the purpose of defining privacy policies that will govern how location tracking privacy engine 104 provides location information about each user to context-aware applications/services 106. As noted above, location tracking system 102 may obtain such location information about a user by tracking the user or an object or device associated therewith. Privacy policies can be defined by a user in a highly flexible and context-specific manner such that the execution of a given privacy policy by location tracking privacy engine 102 is dependent on the existence of one or more social, topical, temporal or spatial conditions, which are also referred to herein as “who, what, when and where” (W4) conditions.

Third interface 126 is also advantageously configured to provide users 108 with recommendations regarding the creation of new privacy policies or the modification of existing privacy policies. Location tracking privacy engine 104 is configured to automatically provide such recommendations to a user based on a user request, based on a current context of the user, and/or based on a detected pattern of user behaviors and/or activities. Furthermore, location tracking privacy engine 104 is configured to recommend privacy policies based on privacy policies that have been enacted by other users, including but not limited to privacy policies that have been enacted by like users, by users in like contexts, and/or by users participating in like behaviors/activities.

In one embodiment of the present invention, third interface 126 comprises an API that can be used to build applications by which user systems/devices may interact with location tracking privacy engine 104, although the invention is not so limited.

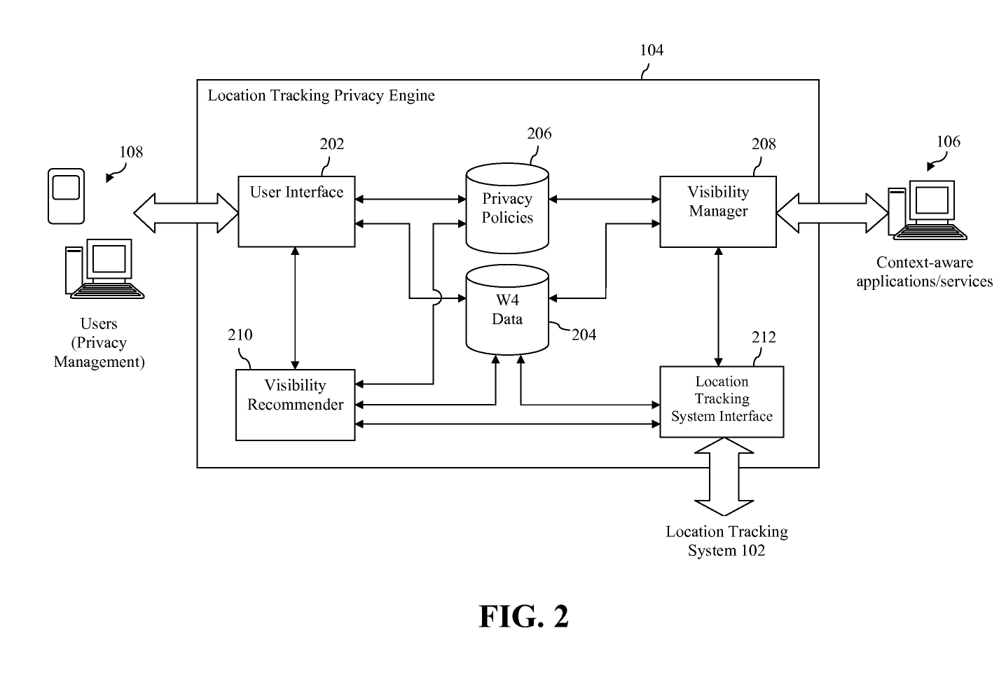

FIG. 2 is a block diagram that depicts location tracking privacy engine 104 in more detail. As shown in FIG. 2, location tracking privacy engine 104 includes a number of communicatively-connected elements including a user interface 202, a W4 data database 204, a privacy policies database 206, a visibility manager 208, a visibility recommender 210 and a location tracking system interface 212. Each of these elements will now be described.

1. User Interface 202

User interface 202 is a component that is configured to allow a user to interact with location tracking privacy engine 104 from a remote location for the purpose of specifying privacy policies that will govern how location tracking privacy engine 104 provides location information about the user to context-aware applications/services 106, as well as to optionally provide other information or perform other functions relating to the provision of such user location information. Privacy policies specified by a user are stored in privacy policies database 206. Other information provided by a user that may be useful in specifying and/or enforcing a privacy policy (e.g., social information, topical information, temporal information or spatial information associated with the user) may be provided via user interface 202 and stored in W4 data database 204.

User interface 202 is also configured to present recommendations regarding the creation of new privacy policies or the modification of existing privacy policies to a user. Such recommendations are generated by visibility recommender 210 in a manner to be described in more detail herein.

User interface 202 may be implemented using a Web service and a standard set of Web APIs for utilizing the Web service. Web applications built upon the Web service may be published by an entity that owns and/or operates location tracking privacy engine 104 or by other entities. Such Web applications are accessed by users using Web browsers in a well-known fashion.

Any of a wide variety of systems/devices may be used to interact with user interface 202, including but not limited to electronic systems/devices having wired or wireless network communication functionality. A system/device used to interact with user interface 202 may also be one of tracked entities 1 10. In one embodiment, communication between users and user interface 202 occurs over the Internet. However, the invention is not so limited, and communication between users and user interface 202 may occur over any type of network or combination of networks including wide area networks, local area networks, private networks, public networks, packet networks, circuit-switched networks, and wired or wireless networks.

2. W4 Data Database 204

W4 data database 204 is configured to store data associated with users of location tracking privacy engine 104 that may be used by location tracking privacy engine 104 to determine when the proper conditions or context exist for enforcing a particular privacy policy for a user. The data stored in W4 data database 204 is also used by location tracking privacy engine 104 to identify and recommend privacy policies to a user in a manner that will be described in more detail herein. The user data stored in W4 data database 204 may be actively provided by a user (such as via user interface 202) or provided by one or more networks, systems or databases that aggregate such data, or by a combination of the foregoing. An example of a system that uses a sensor network to collect user data of the type stored in W4 data database 204 is extensively described in commonly-owned, co-pending U.S. patent application Ser. No. 11/953,494 entitled “System and Method for Conditional Delivery of Messages,” the entirety of which is incorporated by reference as if fully set forth herein.

Although W4 data database 204 is shown as a single database in FIG. 2, it is to be understood that depending on volume, the W4 data may be stored in numerous databases. Such databases may be managed by numerous database servers in communication with location tracking privacy engine 104.

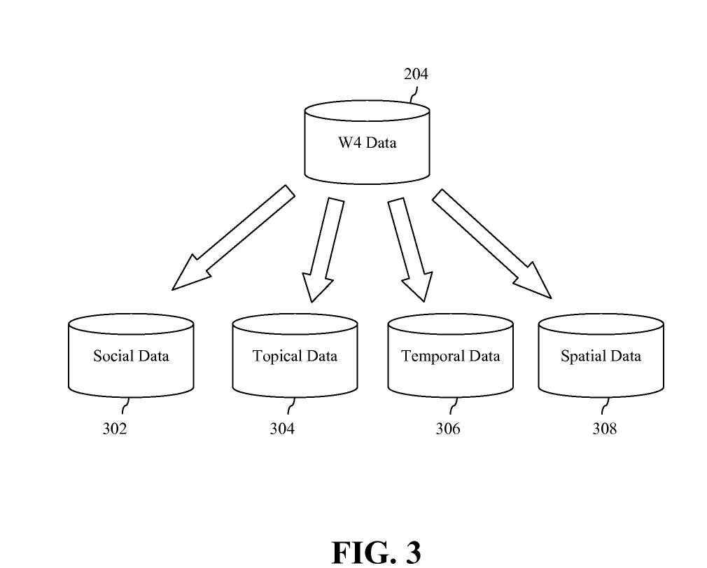

As shown in FIG. 3, the data stored in W4 data database 204 may include social data 302, topical data 304, temporal data 306 and spatial data 308. Such categories of data are also respectively referred to herein as “who, what, when and where” data, or W4 data. The W4 data stored in database 204 may also include information deduced or derived from social data 302, topical data 304, temporal data 306 and spatial data 308, as will be discussed in more detail herein.

Social data 302 may be any data or metadata relating to the relationships of a user. For example, social data 302 may include user identity data, such as gender, age, race, name, social security number, photographs and other information associated with the user's identity. User identity information may also include e-mail addresses, login names and passwords. Social data 302 may also include social network data.

Social network data includes data relating to any relation of a user that is input by the user, such as data relating to a user's friends, family, co-workers, business relations, and the like. Social network data may include, for example, data corresponding with a user-maintained electronic address book. Certain social data may be correlated with, for example, location information to deduce social network data, such as primary relationships (e.g., user-spouse, user-children and user-parent relationships) or other relationships (e.g., user-friends, user-co-worker, user-business associate relationships) and may be weighted by primacy.

Topical data 304 may be any data or metadata concerning subject matter in which a user appears to have an interest or is otherwise associated. Topical data 304 may be actively provided by a user (such as via user interface 202) or may be derived from other sources.

Both social data 302 and topical data 304 may be derived from interaction data. As used herein, the term interaction data refers to any data associated with interactions carried out by a user via an electronic system/device, whether active or passive. Examples of interaction data include interpersonal communication data, media data, transaction data and system/device interaction data.

Interpersonal communication data may be any data or metadata that is received from or sent by an electronic system/device and that is intended as a communication to or from the user. For example, interpersonal communication data may include any data associated with an incoming or outgoing SMS message, e-mail message, voice call (e.g., a cell phone call, a voice over IP call), or other type of interpersonal communication relative to an electronic system/device, such as information regarding who is sending and receiving the interpersonal communication(s). As described below, interpersonal communication data may be correlated with, for example, temporal data to deduce information regarding frequency of communications, including concentrated communication patterns, which may indicate user activity information.

Media data may be any data or metadata relating to presentable media, such as audio data, visual data and audiovisual data. Audio data may be, for example, data relating to downloaded music, such as genre, artist, album and the like, and may include data regarding ringtones, ring backs, media purchased, playlists, and media shared, to name a few. Visual data may be data relating to images and/or text received by an electronic device (e.g., via the Internet or other network). Visual data may include data relating to images and/or text sent from and/or captured at an electronic system/device. Audiovisual data may include data or metadata associated with any videos captured at, downloaded to, or otherwise associated with an electronic system/device.

Media data may also include media presented to a user via a network, such as via the Internet, data relating to text entered and/or received by a user using the network (e.g., search terms), and data relating to interaction with the network media, such as click data (e.g., advertisement banner clicks, bookmarks, click patterns and the like). Thus, media data may include data relating to a user's RSS feeds, subscriptions, group memberships, game services, alerts, and the like. Media data may also include non-network activity, such as image capture and/or video capture using an electronic device, such as a mobile phone. Image data may include metadata added by a user, or other data associated with an image, such as, with respect to photos, location at which the photos were taken, direction of the shot, content of the shot, and time of day, to name a few. As described in further detail below, media data may be used for example, to deduce activities information or preferences information, such as cultural and/or buying preferences information.

Interaction data may also include transactional data or metadata. Transactional data may be any data associated with commercial transactions undertaken by a user via an electronic system/device, such as vendor information, financial institution information (e.g., bank information), financial account information (e.g., credit card information), merchandise information and cost/prices information, and purchase frequency information, to name a few. Transactional data may be utilized, for example, to deduce activities and preferences information. Transactional information may also be used to deduce types of devices and/or services owned by a user and/or in which a user may have an interest.

Interaction data may also include system/device interaction data and metadata. System/device interaction data may be any data relating to a user's interaction with an electronic system/device not included in any of the above categories, such as data relating to habitual patterns associated with use of an electronic system/device. Example of system/device interaction data include data regarding which applications are used on an electronic system/device and how often and when those applications are used. As described in further detail below, system/device interaction data may be correlated with temporal data to deduce information regarding user activities and patterns associated therewith.

Temporal data 306 is time-based data (e.g., time stamps) or metadata (e.g., expiration dates) that relate to specific times and/or events associated with a user and/or an electronic system/device associated with the user. For example, temporal data 306 may include passively-collected time data (e.g., time data from a clock resident on an electronic system/device, or time data from a network clock), or actively-collected time data, such as time data entered by the user of the electronic system/device (e.g., a user-maintained calendar).

Spatial data 308 may be any information associated with a location of the user and/or an electronic system/device associated with the user. For example, spatial data 306 may include any passively-collected location data, such as cell tower data, GPRS data, GPS data, WI-FI data, personal area network data, IP address data and data from other network access points, or actively-collected location data, such as location data entered into a system/device by a user. Spatial data 308 may also include weather data associated with various locations. In one embodiment, spatial data 308 is obtained, at least in part, from location tracking system 104 via location tracking system interface 212.

The W4 data stored in database 204 may also include deduced information. The deduced information may be deduced based on one or more of social data 302, topical data 304, temporal data 306, and social data 308 as described above. The deduced information may thus include information relating to deduced locations and/or deduced activities of the user. For example, the deduced information may comprise one or more of a primary user location, secondary user location, past locations, present location, and predicted future location information. The deduced information may include information deduced based on a correlation of spatial data 308 in conjunction with temporal data 306 to deduce such location data. By way of illustration, spatial data 308 may be correlated with temporal data 306 to determine that a user of an electronic system/device is often at one or more specific locations during certain hours of the day. In a particular embodiment, spatial data 308 is correlated with temporal data 306 to determine a primary user location (e.g., home), a secondary location (e.g., school or work) and/or other locations, as well as a cyclical model for a user's spatial/temporal patterns.

The deduced information may also include activity information, such as past activity information, present activity information, and predicted future activity information. In this regard, the past, present, or predicted future activity information may include information relating to past communications and/or co-locations with other users. By way of example, spatial data 308 may be correlated with temporal data 306 to determine a user's activities (e.g., work, recreation and/or home activities).

The deduced information may also include preferences information. The preferences information may include cultural preferences and/or buying preferences information. The cultural preferences information may be any preferences information relating to the culture of the user, such as gender preferences, ethnicity preferences, religious preferences and/or artistic preferences, to name a few. The buying preferences may be any preferences associated with the buying habits of the user. All preferences may be explicitly provided by a user or implicitly derived from aggregated user and network data.

3. Privacy Policies Database 206

Privacy policies database 206 is configured to store privacy policies specified by users via interaction with user interface 202, wherein such privacy policies govern how location tracking privacy engine 104 provides location information about the user to context-aware applications/services 106.

Among other things, a privacy policy may include both a location reporting methodology and one or more conditions under which the location reporting methodology is to be enforced. The location reporting methodology defines how user location information obtained by location tracking system 104 should be provided to context-aware applications/services 106 and may include providing the location information, not providing the location information, modifying the content or granularity of the location information, selectively providing the location information to certain applications/services or users thereof, and/or selectively modifying the content or granularity of the location information based on a recipient application/service or user thereof. The set of conditions under which the location reporting methodology is to be enforced may be defined such that enforcement depends upon the existence of one or more social, topical, temporal or spatial conditions.

Although privacy policies database 206 is shown as a single database in FIG. 2, it is to be understood that depending on volume, the privacy policies may be stored in multiple databases. Such databases may be managed by multiple database servers in communication with location tracking privacy engine 104.

4. Visibility Manager 208

Visibility manager 208 is a component that is configured to receive location information about a user from location tracking system interface 212 and to automatically control how such user location information is to be provided to context-aware applications/services 106. To perform this function, visibility manager 208 is configured to access privacy policies specified by the user that are stored in privacy policies database 206. As noted above, each privacy policy may include a location reporting methodology and one or more conditions under which the location reporting methodology is to be enforced. Visibility manager 208 is further configured to access W4 data database 204 to determine whether the condition(s) associated with each of the privacy policies specified by the user exist. If the condition(s) associated with a particular privacy policy exist, visibility manager 208 will enforce that policy by applying the location reporting methodology to the user location information before providing the user location information to context-aware applications/services 106.

5. Visibility Recommender 210

Visibility recommender 210 is a component that is configured to generate recommendations regarding the creation of new privacy policies or the modification of existing privacy policies for a user and to provide such recommendations to the user via user interface 202. Visibility recommender 210 may automatically provide such recommendations responsive to a user request provided via user interface 202. Visibility recommender 210 may also automatically provide such recommendations responsive to a current context of the user, as determined by accessing W4 data associated with the user and stored in database 204. Visibility recommender 210 may further automatically provide such recommendations responsive to a detected pattern of user behaviors and/or activities, wherein the detected pattern may be identified by analyzing W4 data associated with the user and stored in database 204 over time.

Visibility recommender 210 may also be configured to recommend privacy policies to a user that have been specified by other users of location tracking privacy engine 104. To perform this function, visibility recommender 210 may recommend privacy policies that have been specified by like users, wherein the similarity of a user with another user is determined by analyzing W4 data associated with both users, such W4 data being stored in W4 data database 204. To perform this function, visibility recommender 210 may also recommend privacy policies that have been enacted by users in like contexts, wherein the similarity of contexts is determined by analyzing the data in W4 data database 204. Visibility recommender 210 may further perform this function by recommending privacy policies specified by users participating in like behaviors/activities, wherein participation in like behaviors/activities is determined by analyzing the data in W4 data database 204.

6. Location Tracking System Interface 212

Location tracking system interface 212 is a component that is configured to manage all communication between location tracking system 102 and location tracking privacy engine 104. Among other functions, location tracking system interface 212 is configured to forward user location information obtained by location tracking system 102 to visibility manager 208 so that visibility manager 208 can apply a location reporting methodology thereto prior to reporting or disseminating such user location information to context-aware applications/services 106. Location tracking system interface 212 may also be configured to provide user location information for storage along with other spatial data in W4 data database 204 or to visibility recommender 210 so that visibility recommender 210 can determine whether the proper context exists for recommending a privacy policy to user or can recommend an appropriate privacy policy based on the user location information.

### C. Specification and Automated Enforcement of Location Tracking Privacy Policies

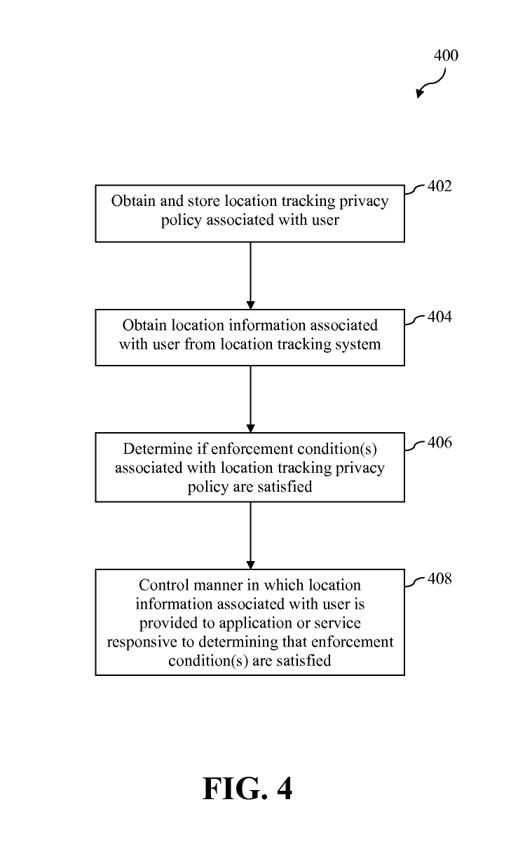

FIG. 4 depicts a flowchart 400 of a method for enabling a user to control the manner in which location information associated with the user is provided to a context-aware application or service in accordance with an embodiment of the present invention. The steps of flowchart 400 will now be described with continued reference to exemplary location tracking privacy engine 104 described above in reference to FIGS. 1 and 2, although the method is not limited to that implementation.

As shown in FIG. 4, the method of flowchart 400 begins at step 402 in which a location tracking privacy policy associated with the user is obtained and stored. As noted above, the user may specify such a privacy policy through interaction with user interface 202, which subsequently stores the privacy policy in privacy policies database 206.

In one embodiment, the privacy policy includes at least a location reporting methodology and one or more enforcement conditions. The location reporting methodology defines how location information received from location tracking system 102 is to be provided to context-aware applications/services 106. The location reporting methodology may include any one of the following methodologies: (1) providing the user location information in an unmodified fashion; (2) not providing the user location information at all; (3) modifying the content of the user location information; (4) providing the user location information only at a specified level of granularity; (5) selectively providing the user location information to certain applications/services or to users thereof, and (6) selectively modifying the content or granularity of the user location information based on a recipient application/service or a user thereof.

Modifying the content of the user location information may include substituting new user location information for the user location information obtained from location tracking system 102. For example, the new user location information may be indicative of some default location associated with the user or a false location of the user.

Providing the user location information at a specified level of granularity refers to the fact that the location of a user may be reported with varying levels of precision. For example, the actual location of a user may be specified very precisely by providing a set of latitude and longitude coordinates that specify where the user is located or less precisely by providing a range of latitude and longitude coordinates within which the user is located. As another example, the actual location of a user may be specified very precisely by providing a full address at which the user is located, including street address, city, state and zip code, or less precisely by only providing the city name, state name or zip code.

Like actual location information, relative location information may also be reported at varying levels of granularity. This is because the proximity of a user to a person, device or object may be reported with different levels of precision. For example, the proximity of a first user to a second user may be specified by indicating that the second user is within 10 meters of the first user or, alternatively, may be specified less precisely by indicating that the second user is within 500 meters of the first user.

The enforcement condition(s) associated with a location tracking privacy policy serve to specify a context within which the location reporting methodology is to be applied. The enforcement condition(s) may be based on any social, topical, temporal or spatial data or conditions associated with the user. Such condition(s) may be reflected by data stored in W4 data database 204 as described above.

At step 404, location information associated with the user is obtained from a location tracking system. As noted above, the location information associated with the user may be obtained from location tracking system 102 by location tracking system interface 212. The user location information received in step 404 may be indicative of a past, current or future location of the user. Furthermore, the user location information received in step 404 may comprise actual location information (e.g., latitude/longitude coordinates, zip code, street address, or the like) as well as relative location information that indicates or identifies the proximity of the user to other users, devices, beacons, or the like.

At step 406, it is determined whether the enforcement condition(s) associated with the location tracking privacy policy obtained and stored in step 402 have been satisfied. As noted above, in location tracking privacy engine 204, visibility manager 208 performs this function by accessing the privacy policy in privacy policies database 206 to determine what the enforcement condition(s) are and then by determining whether the enforcement condition(s) have been satisfied. Determining whether the enforcement condition(s) have been satisfied may include accessing and analyzing data in W4 data database 204.

At step 408, responsive to a determination that the enforcement condition(s) associated with the privacy policy have been satisfied, the manner in which the location information associated with the user is provided to at least one application or service is controlled in accordance with the location reporting methodology associated with the privacy policy. As noted above, in location tracking privacy engine 204, visibility manager 208 performs this function by applying the location reporting methodology to the user location information before providing the user location information to context-aware applications/services 106.

To enhance a further understanding of the method of flowchart 400 and to better exhibit the advantages and utility of embodiments of the present invention, various useful location tracking privacy policies that may be specified and automatically applied or enforced by an embodiment of the present invention will now be described. These privacy policies are provided by way of example only and are not intended to limit the present invention.

1. Privacy Policies Based on Intended Recipients/Social Data

A privacy policy may specify that a particular location reporting methodology is to be applied when it is determined that a particular person or categories of persons is intended to receive location information about a user. In one embodiment, visibility manager 208 determines who the intended recipients of location information are through communication with context-aware application/services 106.

In one embodiment, a user may explicitly identify the persons or categories of persons for which a particular location reporting methodology should be applied. For example, using a novel and sophisticated form of “white listing,” a user may explicitly identify persons or categories of persons that should receive the most precise level of location information about the user, while specifying that other persons or categories of persons should receive less granular location information, modified location information or no location information at all. Conversely, using a novel and sophisticated form of “black listing,” a user may explicitly identify persons or categories of persons that should receive no location information about the user or less granular or modified forms of location information about the user. The mapping of location reporting methodologies to persons or categories of persons may be included as part of a privacy policy that is stored in database 206 and enforced by visibility manager 208.

Because an embodiment of the present invention allows a user to associate any of a plurality of different location reporting methodologies with any number of persons or categories of persons, it advantageously allows a user to exercise a significant degree of control over who will receive location information about the user and what type of location information will be received. Thus, for example, a user may specify that family members should always receive the most precise location information, co-workers should receive less precise location information, and everyone else should not receive any location information whatsoever. Of course, this is only one of many possible examples.

In another embodiment of the present invention, the determination of which location reporting methodology should be applied for a particular person may be premised on a degree of social connectedness or intimacy between a user and the person. For example, in one implementation, visibility manager 208 determines a degree of intimacy between a user and an intended recipient of location information about the user based on social data obtained from W4 data database 204. If the degree of intimacy exceeds a high threshold, then visibility manager 208 provides the intended recipient with the most precise level of location information about the user. If the degree of intimacy is less than a low threshold, then visibility manager provides the intended recipient with no location information about the user. If the degree of intimacy is between the high and low threshold, then visibility manager 208 provides the intended recipient with some less precise level of location information about the user. However, this is only one example and various other approaches for correlating location reporting methodologies to degrees of intimacy may be used.

In yet another embodiment of the present invention, the determination of which location reporting methodology should be applied for a particular person may be premised on a type of social relationship between a user and the person. For example, in one implementation, visibility manager 208 determines a type of social relationship (e.g., friend, business associate, stranger) that exists between a user and an intended recipient of location information about the user based on social data obtained from W4 data database 204. In particular, visibility manager 208 may analyze social data stored within W4 data database 204 relating to interactions and connections between the user and the intended recipient and assign a social relationship type based on the analysis. Visibility manager 208 may then use the type of social relationship assigned to determine the location reporting methodology that should be used. For example, visibility manager 208 may provide persons deemed friends with the most precise location information about the user, persons deemed business associates with less precise location information about the user, and persons deemed strangers with no location information about the user. However, this is only one example and various other approaches for correlating location reporting methodologies to types of social relationships may be used.

Since enforcement of the foregoing privacy policies may be based on an analysis of current social information associated with a user, such policies will dynamically adapt over time to ensure that location information about the user is provided in a manner that is appropriately correlated to the current degree of intimacy with an intended recipient of such information and/or to the current type of social relationship shared with the intended recipient.

2. Privacy Policies Based on Topical Data

A privacy policy may specify that a particular location reporting methodology is to be applied when it is determined that the user is engaging in an activity associated with a particular topic or when there is a topical nexus between the user and the intended recipient of the location information about the user. Visibility manager 208 may determine whether or not such conditions exist by analyzing data in W4 data database 204.

For example, a user may enact a privacy policy that prohibits the reporting of location information about the user or that provides less granular location information about the user whenever the user is engaged in an activity associated with a certain topic. The user may set up such a privacy policy to take effect, for example, whenever the user is engaged in an activity during which user privacy is important or during which the user wishes to avoid interruption by others. Such activities may include any type of personal or professional activity.

As another example, a user may enact a privacy policy that allows location information about the user to be reported to persons or entities that share a topical nexus with the user. For example, a user interested in purchasing a car may enact a policy that allows location information about the user to be reported to car dealerships and/or other persons and entities interested in selling cars. These persons and entities can then use the user location information to make contact with the user or to deliver offers, coupons or marketing materials to the user. Alternatively, a user interested in purchasing generally may enact a policy that allows location information about the user to be reported to any entity selling and product or service in which the user is interested, wherein the determination of which products or services the user is interested in is automatically determined by visibility manager 208 based on topical data currently stored in W4 data database 204.

These are but a few examples and numerous other privacy policies may be created that are based on whether a user is engaged in an activity associated with a particular topic or when there is a topical nexus between a user and an intended recipient of the location information about the user.

3. Privacy Policies Based on Temporal Data

A privacy policy may specify that a particular location reporting methodology is to be applied at a certain time or during certain time periods. Visibility manager 208 may determine whether the necessary conditions exist for enforcing such a privacy policy by determining whether a current time matches a specified time or is within a specified time period associated with the privacy policy.

For example, a privacy policy may specify that during certain daytime hours, location information should be reported about a user at a first level of granularity but during evening hours, location information should be reported about the user at a second level of granularity. As another example, a privacy policy may specify that during any calendar days designated as vacation days by a user, no location information about the user should be reported. As yet another example, a privacy policy may specify that for the duration of a conference attended by a user, location information about the user should be reported to any persons attending the conference. As still another example, a privacy policy may specify that during any sale or promotion sponsored by a particular entity or associated with a certain product or service, location information about the user should be reported to the entity sponsoring the sale or promotion so that information about the sale or promotion may be pushed to the user.

These are but a few examples and numerous other privacy policies may be created that are to be enforced at a certain time or during certain time periods.

4. Privacy Policies Based on Spatial Data

A privacy policy may specify that a particular location reporting methodology is to be applied based on the location of a user. Visibility manager 208 may determine whether the necessary conditions exist for enforcing such a privacy policy, for example, by determining whether a location of the user matches a specified location or is within a predefined area, or by determining whether the user is proximate to a specified location, area, person, device or object. Visibility manager 208 may ascertain the location of a user based on location information provided by location tracking system 102 via interface 212 and/or based on spatial data stored within W4 data database 204.

Some examples of privacy policies that are based on the location of a user include: a privacy policy that prevents location information from being reported about a user or that causes less granular location information to be reported about the user when the user is visiting a particular location (e.g., residence, commercial establishment, geographically-defined event, or other location) and does not want others to know that he/she is visiting the location; a privacy policy that causes location information to be reported about a user when the user is visiting a particular location at which the user wants others to know that he/she is visiting the location; a privacy policy that causes location information to be reported about a user when the user is proximate to a person or type of person in which the user has or is interested in establishing a personal or professional relationship; a privacy policy that prevents location information from being reported about a user or that causes less granular location information to be reported about the user when the user is proximate to a person or type of person the user wants to avoid; and a privacy policy that causes location information to be reported about a user when the user is proximate to a commercial establishment or other vendor of a product or service in which the user is interested so that the commercial establishment or other vendor can contact or provide offers, promotions or marketing materials to the user.

These are but a few examples and numerous other privacy policies may be created that are to be enforced based on a location of the user.

5. Privacy Policies Based on Combinations of Social, Topical, Temporal and Spatial Data

In accordance with an embodiment of the present invention, privacy policies may be enacted in which the conditions for enforcing a particular location reporting methodology may be premised on any combination of social, topical, temporal and spatial data associated with a user, thereby providing users with a highly flexible and context-specific means for controlling the disclosure of personal location information. The use of a plurality of location reporting methodologies coupled with a wide variety of context-specific enforcement variables enables users to control their personal location information is precise manner that is custom-tailored to their privacy and security needs.

### D. Management of Logged User Location Information

Depending upon the implementation, location tracking system 102 shown in FIG. 1 may include or maintain one or more logs that store location information. Such location information may be periodically provided by or obtained from devices and objects associated with users as well as by other objects and devices. For example, location tracking system 102 may represent a location tracking system such as that described in U.S. patent application Ser. No. 12/028,422 to Davis et al., filed Feb. 8, 2008, the entirety of which is incorporated by reference as if fully set forth herein. As described in that application, the location tracking system is configured to establish a proximity-based ad hoc network among a plurality of sensor-enabled devices that may be used to track the locations of users associated with certain ones of the sensor-enabled devices. To perform this function, the location tracking system is configured to periodically log time-stamped location information received from the sensor-enabled devices. The location information may identify an actual location of a sensor-enabled device or identify a location of a sensor-enabled device relative to other sensor-enabled devices or beacons. The time stamp may indicate when such location information was generated or obtained.

Such logged location information represents information that may be deemed extremely private to a user, since the logged location information may be used to determine the location of the user at various points in time, including during the past, the present, and potentially the future (based on some form of extrapolation). As described above, location tracking privacy engine 104 operates to protect a user's privacy and/or security by selectively applying location reporting methodologies to user location information received from location tracking system 102 before providing such location information to context-aware applications/services 106, wherein the application of the location reporting methodologies may result in the non-delivery or obscuring of such location information. However, the application of such location reporting methodologies does not in any way affect the logged location information stored by location tracking system 102.

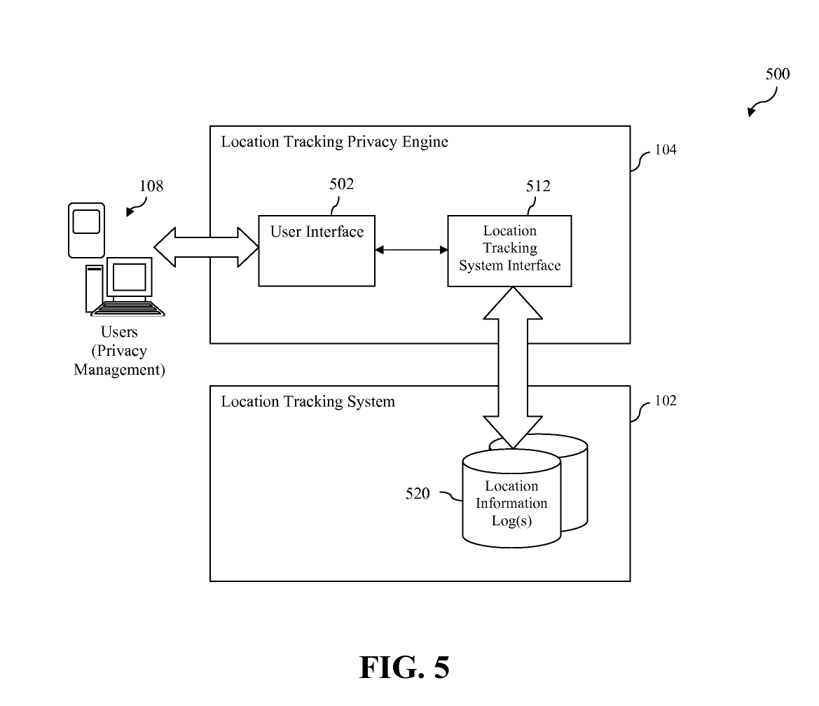

Consequently, users may wish to have access to logged location information stored by location tracking system 102 to modify such information, wherein modifying such information may include deleting or changing the content of the information, thereby ensuring that user privacy and/or security is fully protected. FIG. 5 depicts a system 500 in accordance with an embodiment of the present invention that addresses this desire by enabling a user to modify logged location information associated with the user.

System 500 may be thought of as a particular implementation of system 100 of FIG. 1. Like system 100, system 500 includes location tracking system 102 and location tracking privacy engine 104 communicatively coupled thereto. As shown in FIG. 5, location tracking system 102 includes one or more location information logs 520 that are used to store time-stamped location information periodically sent by or retrieved from one or more sensor-enabled devices or objects.

As further shown in FIG. 5, location tracking privacy engine 104 includes a user interface 502 and a location tracking system interface 512 that is communicatively coupled thereto. User interface 502 is configured to allow users 108 to access location information log(s) 520 stored in or by location tracking system 102 via a location tracking system interface 512. User interface 502 is further configured to allow a user to find location information associated with the user in log(s) 520 and to modify or delete such location information. Location tracking system interface 512 is configured to manage all necessary communication between location tracking privacy engine 504 and location tracking system 502 in support of these functions.

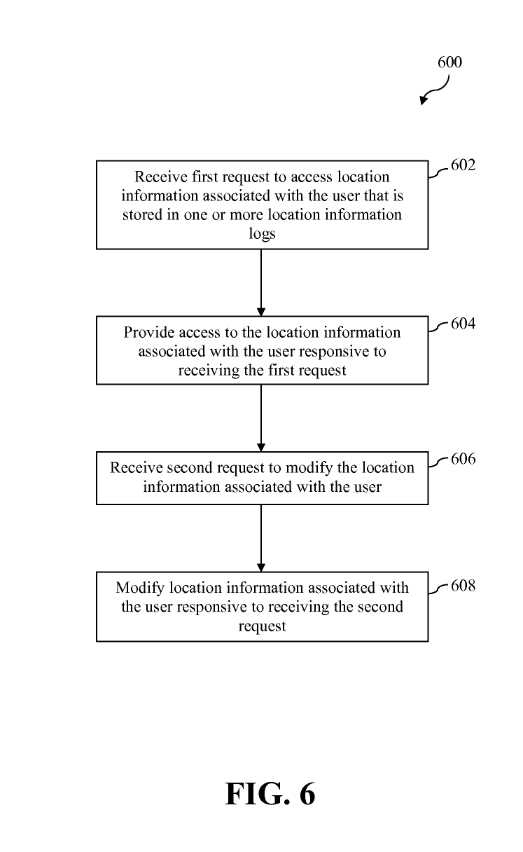

FIG. 6 is a flowchart 600 of one method for enabling a user to modify logged location information associated with the user in accordance with an embodiment of the present invention. Although the steps of flowchart 600 will now be described with continued reference to system 500 of FIG. 5, the method is not limited to that implementation.

As shown in FIG. 6, the method of flowchart 600 begins at step 602, in which a first request is received to access location information associated with the user that is stored in one or more location information logs 520. In an embodiment, the first request is generated by user interface 502 responsive to user input and is delivered to location tracking system interface 512, which receives it.

At step 604, the user is provided with access to the location information associated with the user responsive to receiving the request. In an embodiment, location tracking system interface 512 performs this function by accessing log(s) 520 responsive to receiving the first request and providing a copy of the relevant location information associated with the user from log(s) 520 to user interface 502 for presentation to the user. The accessed location information may include location information reported to location tracking system by a sensor-enabled device associated with the user or by some other sensor-enabled device, including but not limited to sensor-enabled devices associated with other users.

At step 606, a second request is received to modify the location information associated with the user. In an embodiment, the second request is generated by user interface 502 responsive to user input and is delivered to location tracking system interface 512, which receives it. Modifying the location information associated with the user may comprise deleting the location information associated with the user. Alternatively, modifying the location information associated with the user may comprise changing the content of the location information associated with the user. Changing the content of the location information associated with the user may comprise, for example, changing actual or proximate location data included in the location information, changing a time stamp associated with such location data, or changing an identifier of a device or user associated with such location data, although these examples are not intended to be limiting.

At step 608, the location information associated with the user is modified in the manner specified by the second request responsive to receiving the second request. In an embodiment, location tracking system interface 512 performs this function by accessing log(s) 520 responsive to receiving the second request and modifying the relevant location information associated with the user in log(s) 520 in the manner specified by the second request. As noted above, this may include deleting location information from log(s) 520 or changing the content of location information stored in log(s) 520.

### E. Avoidance of Derived Disclosure of User Location

The location of a user may be determined not only from location information obtained from a device or object associated with the user but also from other sensor-enabled devices or objects that are associated with other users or that are not associated with any users. For example, consider a situation in which a first user is carrying a first device associated with the first user that includes both GPS and Bluetooth™ functionality and that is configured to periodically report GPS data to location tracking system 102. To protect the privacy of the user, visibility manager 208 may be configured to enforce a privacy policy that prohibits the GPS data reported from the first device to be provided to context-aware applications/services 106.

However, further assume that a second user is carrying a second device associated with the second user that includes both GPS and Bluetooth™ functionality and that this second device is configured to periodically report both GPS data and data identifying any Bluetooth™ device currently within 10 meters of the second device to location tracking system 102. Assume further that the first device is within 10 meters of the second device such that the second device detects the first device and reports the detection of the first device to location tracking system 102. In this scenario, the location information reported from the second device is sufficient to locate the first user with a great degree of precision. In particular, the GPS information reported by the second device very precisely locates the second user, and the proximity information reported by the second device very precisely locates the first user within 10 meters of the second user.

Other situations can be imagined in which location information received from devices or objects that are not associated with a user can nevertheless be used to determine the location of the user. For example, in the location tracking system described in U.S. patent application Ser. No. 12/028,422 to Davis et al., filed Feb. 8, 2008, actual location information associated with a single user can be used to ascertain the location of numerous other users in a network of proximally-located users.

To account for such situations, it may not be sufficient for visibility manager 208 to enforce privacy policies enacted by a user by controlling the reporting of location information collected only from devices or objects associated with the user. Rather, as can be seen from the foregoing example, visibility manager 208 must also be configured to control the reporting of location information collected from other devices or objects that are not associated with the user when such location information can be used to derive the location of the user.

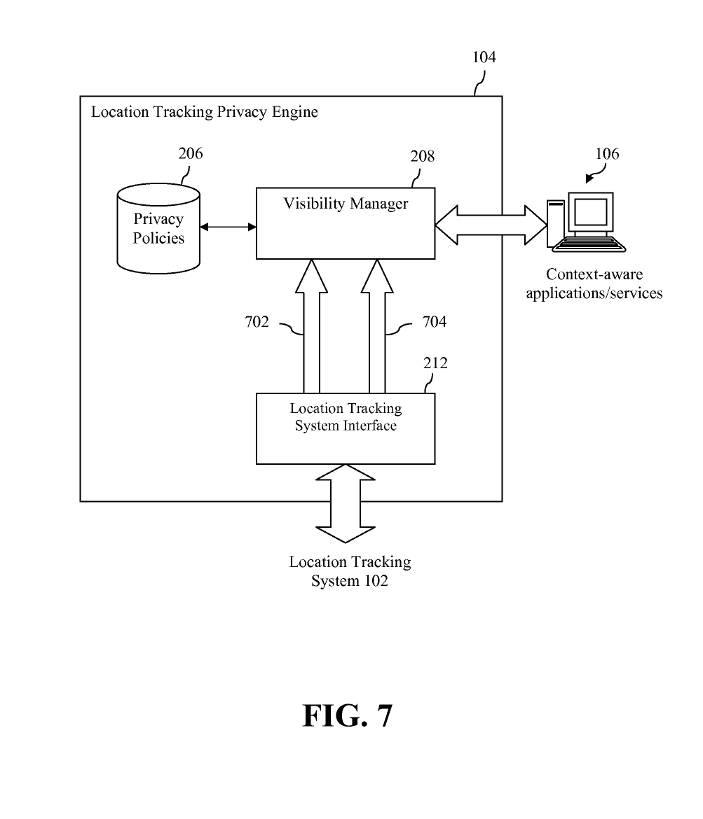

FIG. 7 is a block diagram of an embodiment of the present invention in which visibility manager 208 is so configured. As shown in FIG. 7, visibility manager 208 is configured to receive both location information 702 and location information 704 from location tracking system 102 via location tracking system interface 212. Location information 702 is intended to represent location information obtained from one or more devices or objects associated with a particular user. Location information 704 is intended to represent location information obtained from one or more devices or objects that are not associated with the particular user, including but not limited to one or more devices that are associated with other users.

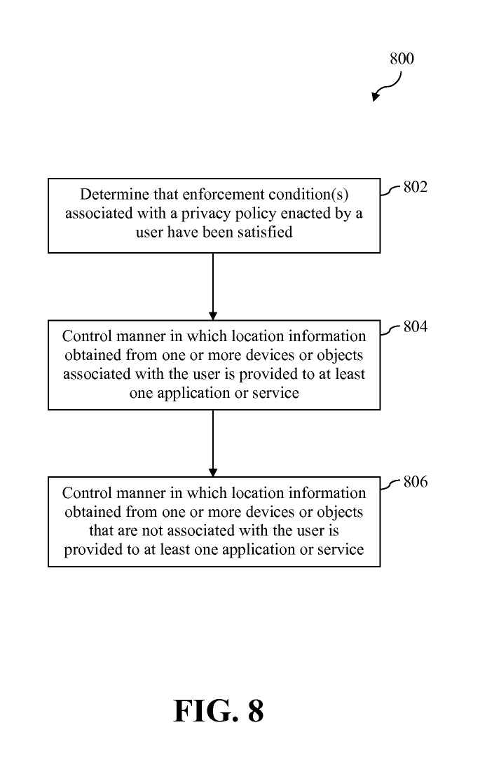

The manner in which visibility manager 208 operates to control both types of location information to protect the privacy and/or security of a user will now be described in reference to flowchart 800 of FIG. 8. As shown in FIG. 8, the method of flowchart begins at step 802 in which visibility manager 208 determines that the enforcement condition(s) associated with a privacy policy enacted by a user have been satisfied. As noted above, such privacy policies are stored in a privacy policies database 206 and accessed therefrom by visibility manager 208.

At step 804, responsive to determining that the enforcement condition(s) associated with the privacy policy have been satisfied, visibility manager 208 controls the manner in which location information 702 obtained from one or more devices or objects associated with the user is provided to at least one of context-aware applications/services 106. Visibility manager 208 performs this function by applying the location reporting methodology associated with the privacy policy to location information 702 before providing such information to context-aware applications/services 106. As previously discussed, the application of the location reporting methodology may include any of: (1) providing location information 702 in an unmodified fashion; (2) not providing location information 702 at all; (3) modifying the content of location information 702; (4) providing location information 702 only at a specified level of granularity; (5) selectively providing location information 702 to certain applications/services or to users thereof, and (6) selectively modifying the content or granularity of location information 702 based on a recipient application/service or a user thereof.

At step 806, also responsive to determining that the enforcement condition(s) associated with the privacy policy have been satisfied, visibility manager 208 controls the manner in which location information 704 obtained from one or more objects or devices that are not associated with the user is provided to at least one of context/aware applications/services 106. Visibility manager 208 performs this function to ensure that location information 704 is not provided in a form or manner that may cause the location reporting methodology associated with the privacy policy to be violated. Thus, for example, if the location reporting methodology associated with the privacy policy indicates that the location of the user should not be reported at a level that is more granular than 500 meters, visibility manager 208 will modify or prohibit location information 704 from being reported if it could be used to derive the location of the user at a 10 meter granularity level. This step may include any of: (1) providing location information 704 in an unmodified fashion; (2) not providing location information 704 at all; (3) modifying the content of location information 704; (4) providing location information 704 only at a specified level of granularity; (5) selectively providing location information 704 to certain applications/services or to users thereof, and (6) selectively modifying the content or granularity of location information 704 based on a recipient application/service or a user thereof.

Depending upon the implementation, the amount of location information 704 that is analyzed by visibility manager 208 in enforcing a privacy policy for a user may be limited to the location information that is most likely to lead to the derivation of the location of the user. For example, only location information obtained from devices associated with users that are proximally located to the user or that are socially connected to the user may be analyzed, since that is the type of location information from which the location of the user is most likely to be derived.

In a further embodiment, location tracking privacy engine 104 is configured to receive location information about a user from two or more location tracking systems and to analyze the location information from both sources to ensure that there is no direct or derived disclosure of user location in violation of a user privacy policy.

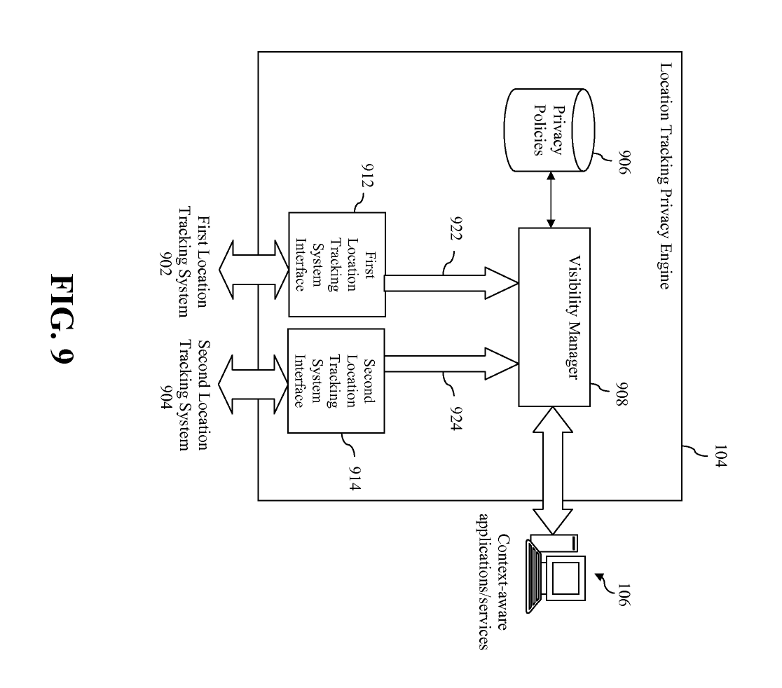

Such an implementation is shown in FIG. 9. In particular, as shown in FIG. 9, location tracking privacy engine 104 includes a visibility manager 908 that is configured to receive first location information 922 about a user from a first location tracking system 902 via a first location tracking system interface 912 and to receive second location information 924 about the user from a second location tracking system 904 via a second location tracking system interface 914. Visibility manager 908 is further configured to control the manner in which both first location information 922 and second location information 924 is provided to at least one of context/aware applications/services 106 based on a privacy policy enacted by the user.

F. Automatic Recommendation of Location Tracking Privacy Policies

In accordance with an embodiment of the present invention, location tracking privacy engine 104 is advantageously configured to automatically provide users 108 with recommendations regarding location tracking privacy policies that may be appropriate to enact in certain contexts and a means for enacting such policies. The recommended privacy policies may represent privacy policies that have been enacted by other users in like contexts.

By providing such recommendations, an embodiment of the present invention may assist a user in making a good decision about what location tracking privacy policy would be best in a particular context. Furthermore, by providing such recommendations, an embodiment of the present invention can help guide a user in defining a sophisticated array of privacy policies that are customized to many different contexts. Such an embodiment can further appraise users of social norms with respect to location tracking privacy and reporting and also alert users to situations in which current privacy policies do not make sense or will result in bad consequences for the user.

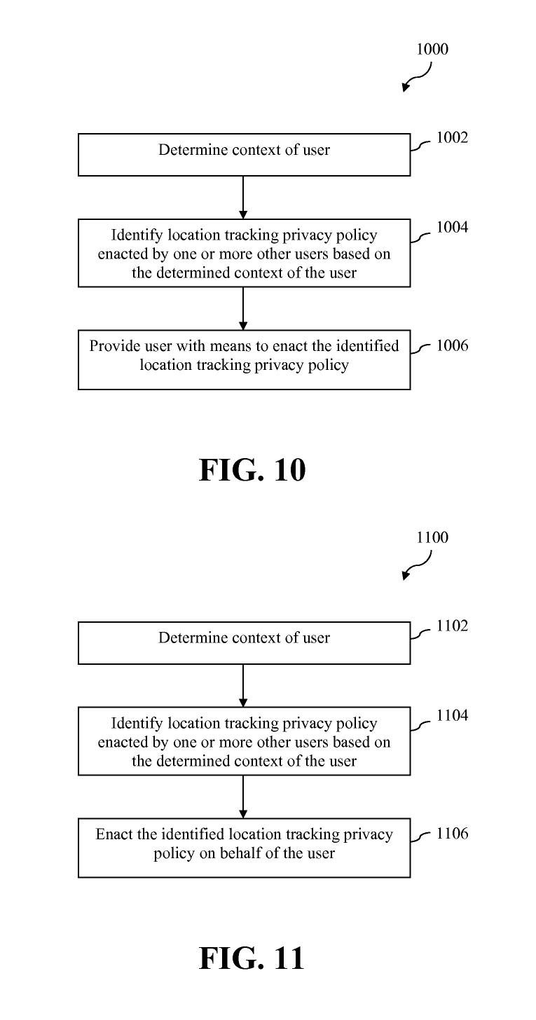

FIG. 10 depicts a flowchart 1000 of a method by which location tracking privacy engine 104 automatically recommends a location tracking privacy policy to a user in accordance with an embodiment of the present invention. Although the steps of flowchart 1000 will now be described with continued reference to the embodiment of location tracking privacy engine 104 depicted in FIG. 2, the method is not limited to that embodiment.

As shown in FIG. 10, the method of flowchart 1000 begins at step 1002 in which visibility recommender 210 determines a current context of a user. In one embodiment, visibility recommender 210 performs this function by analyzing one or more of social, topical, temporal or spatial data associated with the user. Such data may be obtained, for example, from W4 data database 204, user interface 202, or from location tracking system interface 212 where the data to be analyzed includes spatial data.

At step 1004, visibility recommender 210 identifies a location tracking privacy policy that has been enacted by one or more other users of location tracking privacy engine 102 based on the context of the user as determined in step 1002. In an embodiment, visibility recommender 210 performs this function by identifying users that have implemented privacy policies for a context that is the same as or similar to the context identified in step 1002 and by then identifying a location tracking privacy policy that has been enacted by one or more of the identified users. To perform this function, visibility recommender is configured to access user privacy policies stored in privacy policies database 206. The context associated with a privacy policy may be determined from the enforcement condition(s) under which such policy is enforced.

At step 1006, user interface 202 provides the user with a means for enacting the location tracking privacy policy identified by visibility recommender 210 during step 1004. User interface 202 may perform this function, for example, by sending a message or command to a user system/device that causes the system/device to inform the user of the identified location tracking privacy policy and to prompt the user to either enact the identified location tracking privacy policy or to ignore it. Enactment of the identified location tracking policy comprises initiating automatic control of the manner in which location information associated with the user is provided to at least one application or service in accordance with the identified location tracking privacy policy. Such automatic control may be implemented by visibility manager 208 in a manner that was previously described.

The foregoing method may advantageously be used to provide a user with location tracking privacy policy recommendations in a variety of different contexts. For example, such a recommendation may be provided for when the user interacts with, establishes a relationship with, or becomes proximal to certain entities or objects, when a user performs a certain type of activity, when a user enters or reaches a particular location, or at a certain time. Indeed, as noted above, the context of the user that provides the basis for the recommendation may be defined based on any combination of social, topical, temporal and spatial factors.

As noted above, the recommended location tracking privacy policy is one that has been enacted by one or more other users of location tracking privacy engine 104. In one embodiment, visibility recommender 210 is configured to recommend a privacy policy that has been enacted by a majority of all the users of location tracking privacy engine 104 for the same or a like context as the current context of the user. However, depending upon the implementation, visibility recommender 210 may also be configured to recommend privacy policies enacted by selected groups or communities of users, or a majority of such groups or communities of users, in order to provide a more meaningful or interesting privacy policy recommendation to the user. The target group or populations for recommendations may be determined by the system or by the user through interaction with user interface 202.

For example, in one embodiment, visibility recommender 210 is configured to recommend a location tracking privacy policy that has been enacted by one or more other users that are connected to the user within a social network. For example, the recommended privacy policy may be a privacy policy that has been enacted by a majority of the users within a user's social network. Visibility recommender 210 may identify such users for example by accessing social data about the user that is stored in W4 data database 204.

As another example, visibility recommender 210 may be configured to recommend a location tracking privacy policy that has been enacted by one or more other users that are deemed to be similar to the user. Depending upon the implementation, similarity between users may be determined or measured in any number of ways. For example, users may be deemed similar based on any of a variety of factors, including but not limited to age, upbringing, education, profession, income level, race, or religious affiliation. Users may also be deemed similar based on current or past actions or behaviors including the location tracking privacy policies of co-present users and/or users engaged in the same kinds of activities even if at different locations. Visibility recommender 210 may identify similar users for example by comparing any type of W4 data about the user (as stored in W4 data database 204) to any type of W4 data about other users.

As a further example, visibility recommender 210 may be configured to recommend a location tracking privacy policy that has been enacted by one or more other users in a class of users that includes the user. A class may include any grouping of users for any purpose whatsoever and may be defined in any number of ways including socially, economically, professionally, topically, or the like. Visibility recommender 210 may determine whether a user is a member of a class, for example, by accessing and/or analyzing W4 data available in W4 data database 204.

As yet another example, visibility recommender 210 may be configured to recommend a location tracking privacy policy that has been enacted by one or more other users who are participating in an event or visiting a location, wherein the location tracking privacy policy has been selected by an entity running the event or managing the location. This advantageously allows the user to be informed of and comply with a location tracking privacy policy that has been determined by the entity.

Depending upon the implementation, visibility recommender 210 may also be configured to generate comparative information concerning users that have enacted the recommended privacy policy and to provide such comparative information to the user via user interface 202. Such comparative information may include, for example, a percentage of users within a certain group that have enacted the recommended location tracking privacy policy within the relevant context. This comparative information may be used by the user to make a decision regarding whether or not to enact the recommended privacy policy.

Visibility recommender 210 may also be configured to generate information concerning potential consequences associated with enacting or not enacting a recommended location tracking privacy policy and to provide such information to the user via user interface 202. Such information may include, for example, historical data concerning events, interactions, or outcomes that have occurred for other users in like contexts who have enacted or failed to enact the recommended location tracking privacy policy.

Depending upon the implementation, the recommendation of a location tracking privacy policy to a user in accordance with the steps of flowchart 1000 may be executed by location tracking system 104 in response to a number of conditions or events. For example, the method may be executed in direct response to a user request for a recommended location tracking privacy policy, which may be received via user interface 202. Thus, when a user finds himself/herself within a particular context and is unsure what the best location tracking privacy policy is for that context, the user may submit a request to location tracking privacy engine 104 and receive a recommendation.

As another example, location tracking privacy engine 104 may perform the steps of flowchart 1000 responsive to determining that location information about the user is being reported to at least one application or service, or to at least one other user. In such an embodiment, user interface 202 may send an alert to the user along with the privacy policy recommendation indicating that the location of the user is currently being reported to some entity and inquiring whether the user wants to enact the recommended location tracking privacy policy.

As a further example, location tracking privacy engine 104 may perform the steps of flowchart 1000 responsive to determining that a context of the user has changed. For example, if location tracking privacy engine 104 determines that the context of the user has changed and further determines that the user currently has no location tracking privacy policy in place for the new context, that the privacy policy currently in place is not appropriate for the new context, or that the privacy policy is not consistent with what other users in a relevant group have enacted, it may prompt the user to enact a recommended location tracking privacy policy.

In a further embodiment of the present invention, location tracking privacy engine 104 may be configured to automatically enact location tracking privacy policies on behalf of a user without requiring the user to receive or approve recommended privacy policies. In accordance with such an embodiment, the user may completely delegate the task of setting up appropriate location tracking privacy policies to location tracking privacy engine 104, which is capable of using community information to select appropriate and/or commonly-used privacy policies as discussed above. This may be helpful to a user who does not have the time or inclination to set up a location tracking privacy for every context in which they may find themselves.

FIG. 11 depicts a flowchart 1100 of a method by which location tracking privacy engine 104 may automatically enact a location tracking privacy policy on behalf of a user in accordance with an embodiment of the present invention. Although the steps of flowchart 1100 will now be described with continued reference to the embodiment of location tracking privacy engine 104 depicted in FIG. 2, the method is not limited to that embodiment.

As shown in FIG. 11, the method of flowchart 1100 begins at step 1102 in which visibility recommender 210 determines a current context of a user. In one embodiment, visibility recommender 210 performs this function by analyzing one or more of social, topical, temporal or spatial data associated with the user. Such data may be obtained, for example, from W4 data database 204, user interface 202, or from location tracking system interface 212 where the data to be analyzed includes spatial data.

At step 1104, visibility recommender 210 identifies a location tracking privacy policy that has been enacted by one or more other users of location tracking privacy engine 102 based on the context of the user as determined in step 1002. In an embodiment, visibility recommender 210 performs this function by identifying users that have implemented privacy policies for a context that is the same as or similar to the context identified in step 1002 and by then identifying a location tracking privacy policy that has been enacted by one or more of the identified users. To perform this function, visibility recommender is configured to access user privacy policies stored in privacy policies database 206. The context associated with a privacy policy may be determined from the enforcement condition(s) under which such policy is enforced.

At step 1106, visibility recommender 210 enacts the location tracking privacy policy identified during step 1104 on behalf of the user. Enactment of the identified location tracking policy on behalf of the user comprises initiating automatic control of the manner in which location information associated with the user is provided to at least one application or service in accordance with the identified location tracking privacy policy. Such automatic control may be implemented by visibility manager 208 in a manner that was previously described.

### G. Client-Side Implementation

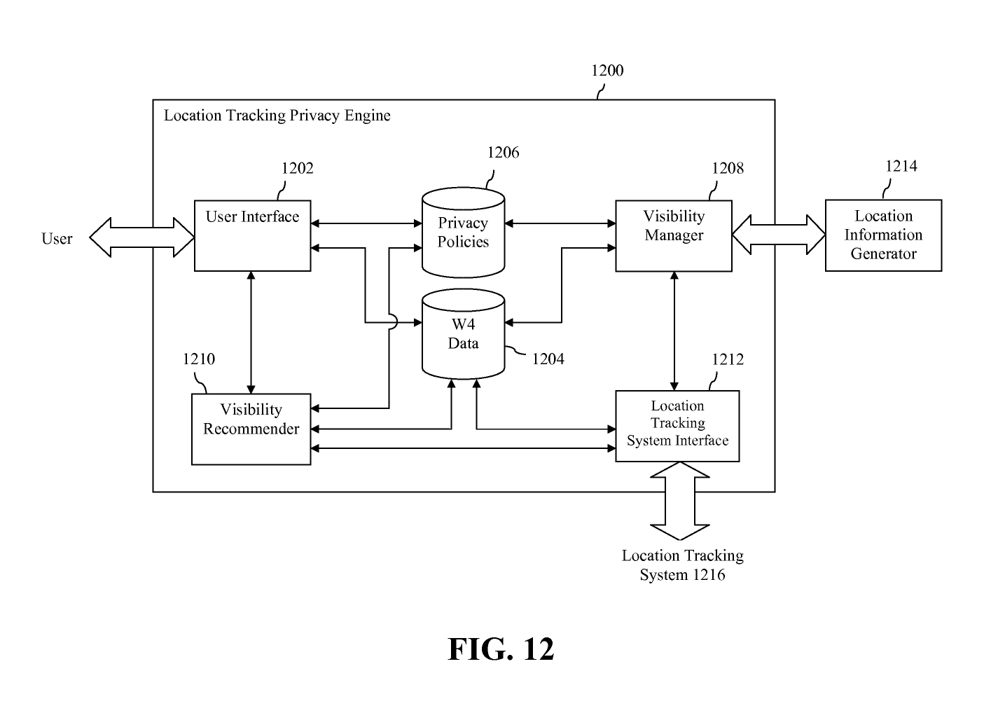

FIG. 12 is a block diagram of a location tracking privacy engine 1200 that may be implemented in a user device to perform similar functions to location tracking privacy engine 104 described above in reference to FIG. 2. As shown in FIG. 12, location tracking privacy engine 1200 includes a number of communicatively connected components including a user interface 1202, a W4 data database 1204, a privacy policies database 1206, a visibility manager 1208, a visibility recommender 1210 and a location tracking system interface 1212.

Location tracking privacy engine 1200 is communicatively connected to a location information generator 1214, which represents logic within or coupled to the user device that is configured to generate information about the location of the device. Such location information may include actual location information or relative location concerning the proximity of other devices, objects or persons. Location information generator 1214 may generate such location information using any of a variety of well-known technologies for producing such location information, including but not limited to GPS technology, Wi-Fi technology, cellular telephony technology and/or Bluetooth™ technology.

Visibility manager 1208 is communicatively connected to location information generator 1214 and is configured to receive location information therefrom. Visibility manager 1208 is further configured to automatically control how such location information is provided to a location tracking system 1216 via a location tracking system interface 1212. To perform this function, visibility manager 208 is configured to access privacy policies specified by the user that are enacted via user interface 1202 and stored in privacy policies database 1206. Each privacy policy may include a location reporting methodology and one or more conditions under which the location reporting methodology is to be enforced. Visibility manager 1208 is further configured to access W4 data database 1204 (which contains like data to W4 data database 204 described above in reference to FIG. 2 or a subset thereof) to determine whether the condition(s) associated with each of the privacy policies specified by the user exist. If the condition(s) associated with a particular privacy policy exist, visibility manager 1208 will enforce that policy by applying the location reporting methodology to the location information before providing the location information to location tracking system 1216.

Like visibility manager 208 described above in reference to FIG. 2, visibility manager 1208 may apply a location reporting methodology to location information provided by location information generator 1214 prior to delivering the location information to location tracking system 102, wherein applying the location reporting methodology may comprise providing the location information, not providing the location information, modifying the content or granularity of the location information, selectively providing the location information to certain applications/services or users thereof, and/or selectively modifying the content or granularity of the location information based on a recipient application/service or user thereof.

In one embodiment, visibility manager 1208 may provide the location information to location tracking system 102 in a manner that preserves the actual or proximal location content of the information but removes any information that can link the location content to the user device or the user. By rendering such information “anonymous,” visibility manager 1208 enables the location information to be sent to and used by location tracking system 1216 in a manner that does not compromise the privacy and/or security of the user. This is particularly useful where the location tracking system is one such as that described in U.S. patent application Ser. No. 12/028,422 to Davis et al., filed Feb. 8, 2008, in which such location content can advantageously be used to establish a proximity-based ad hoc network among a plurality of mobile devices.

Location tracking privacy engine 1200 also includes a visibility recommender 1210 that is configured to generate recommendations regarding the creation of new privacy policies or the modification of existing privacy policies for a user and to provide such recommendations to the user via user interface 1202 in a like manner to visibility recommender 210 as described above in reference to FIG. 2. In particular, visibility recommender 1210 is configured to determine a context of the user, wherein the context of the user may be determined based on social, topical, temporal and/or spatial data associated with the user and stored in W4 data database 1204, to identify a location tracking privacy policy enacted by one or more other users based on the determined context of the user, and to provide the user with a means to enact the identified location tracking privacy policy, wherein enacting the identified location tracking policy comprises initiating automatic control of the manner in which location information associated with the user is provided to a location tracking system 1216 for further provision to an application or service.

### H. Example Computer System Implementation

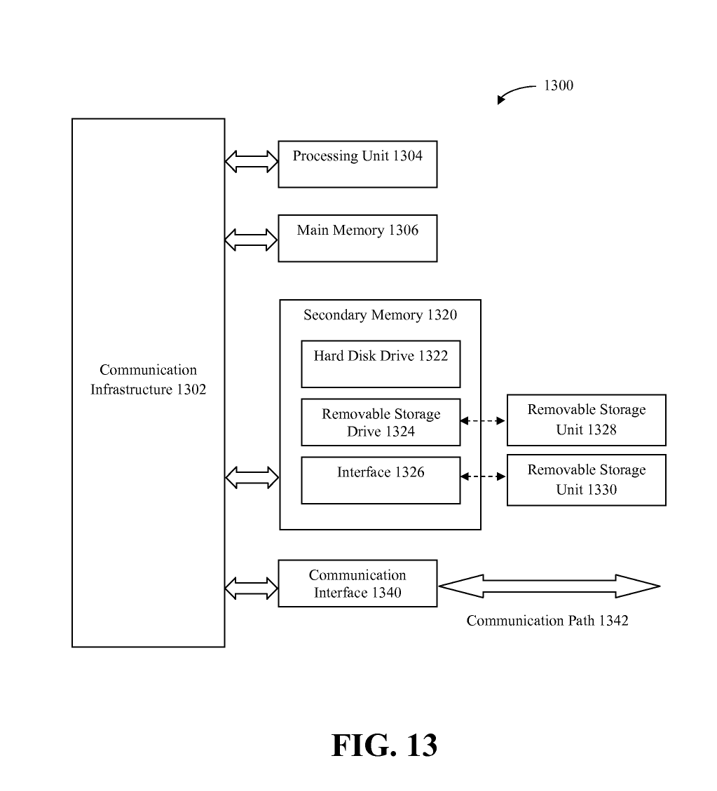

Each of the elements of the various systems depicted in FIGS. 1, 2, 5, 7, 9 and 12 and each of the steps of flowcharts depicted in FIGS. 4, 6, 8, 10 and 11 may each be implemented by one or more processor-based computer systems. An example of such a computer system 1300 is depicted in FIG. 13.

As shown in FIG. 13, computer system 1300 includes a processing unit 1304 that includes one or more processors. Processor unit 1304 is connected to a communication infrastructure 1302, which may comprise, for example, a bus or a network.

Computer system 1300 also includes a main memory 1306, preferably random access memory (RAM), and may also include a secondary memory 1320. Secondary memory 1320 may include, for example, a hard disk drive 1322, a removable storage drive 1324, and/or a memory stick. Removable storage drive 1324 may comprise a floppy disk drive, a magnetic tape drive, an optical disk drive, a flash memory, or the like. Removable storage drive 1324 reads from and/or writes to a removable storage unit 1328 in a well-known manner. Removable storage unit 1328 may comprise a floppy disk, magnetic tape, optical disk, or the like, which is read by and written to by removable storage drive 1324. As will be appreciated by persons skilled in the relevant art(s), removable storage unit 1328 includes a computer usable storage medium having stored therein computer software and/or data.

In alternative implementations, secondary memory 1320 may include other similar means for allowing computer programs or other instructions to be loaded into computer system 1300. Such means may include, for example, a removable storage unit 1330 and an interface 1326. Examples of such means may include a program cartridge and cartridge interface (such as that found in video game devices), a removable memory chip (such as an EPROM, or PROM) and associated socket, and other removable storage units 1330 and interfaces 1326 which allow software and data to be transferred from the removable storage unit 1330 to computer system 1300.

Computer system 1300 may also include a communication interface 1340. Communication interface 1340 allows software and data to be transferred between computer system 1300 and external devices. Examples of communication interface 1340 may include a modem, a network interface (such as an Ethernet card), a communications port, a PCMCIA slot and card, or the like. Software and data transferred via communication interface 1340 are in the form of signals which may be electronic, electromagnetic, optical, or other signals capable of being received by communication interface 1340. These signals are provided to communication interface 1340 via a communication path 1342. Communications path 1342 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1328, removable storage unit 1330 and a hard disk installed in hard disk drive 1322. Computer program medium and computer readable medium can also refer to memories, such as main memory 1306 and secondary memory 1320, which can be semiconductor devices (e.g., DRAMs, etc.). These computer program products are means for providing software to computer system 1300.

Computer programs (also called computer control logic, programming logic, or logic) are stored in main memory 1306 and/or secondary memory 1320. Computer programs may also be received via communication interface 1340. Such computer programs, when executed, enable the computer system 1300 to implement features of the present invention as discussed herein. Accordingly, such computer programs represent controllers of the computer system 1300. Where the invention is implemented using software, the software may be stored in a computer program product and loaded into computer system 1400 using removable storage drive 1324, interface 1326, or communication interface 1340.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### I. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for permitting a user to control the manner in which location information associated with the user is provided to one or more applications or services, comprising:
obtaining a location tracking privacy policy associated with the user, wherein the location tracking privacy policy includes a location reporting methodology and one or more enforcement conditions;
obtaining the location information associated with the user;
determining whether the enforcement condition(s) have been satisfied; and
controlling the manner in which the location information associated with the user is provided to at least one application or service in accordance with the location reporting methodology responsive to determining that the enforcement condition(s) have been satisfied.

2. The method of claim 1, wherein controlling the manner in which the location information associated with the user is provided to the at least one application or service in accordance with the location reporting methodology comprises:
prohibiting the location information associated with the user from being provided to the at least one application or service.

3. The method of claim 1, wherein controlling the manner in which the location information associated with the user is provided to the at least one application or service in accordance with the location reporting methodology comprises:
modifying the location information associated with the user.

4. The method of claim 1, wherein controlling the manner in which the location information associated with the user is provided to the at least one application or service in accordance with the location reporting methodology comprises:
altering a granularity of the location information associated with the user.

5. The method of claim 1, wherein determining whether the enforcement condition(s) have been satisfied comprises:
determining whether a particular person or category of persons is intended to receive the location information associated with the user.

6. The method of claim 5, wherein determining whether a particular person is intended to receive the location information associated with the user comprises:
determining whether a person having a particular degree of social connectedness with the user is intended to receive the location information associated with the user.

7. The method of claim 5, wherein determining whether a particular person is intended to receive the location information associated with the user comprises:
determining whether a person having a particular type of social relationship with the user is intended to receive the location information associated with the user.

8. The method of claim 1, wherein determining whether the enforcement condition(s) have been satisfied comprises:
determining whether the user is engaging in an activity associated with a particular topic.

9. The method of claim 1, wherein determining whether the enforcement condition(s) have been satisfied comprises:
determining whether a topical nexus exists between the user and an intended recipient of the location information about the user.

10. The method of claim 1, wherein determining whether the enforcement condition(s) have been satisfied comprises:
determining whether a current time matches a specified time or is within a specified time period.

11. The method of claim 1, wherein determining whether the enforcement condition(s) have been satisfied comprises:
determining whether a location of the user matches a particular location or is within a particular area.

12. The method of claim 1, wherein controlling the manner in which the location information associated with the user is provided to at least one application or service in accordance with the location reporting methodology comprises:
controlling the manner in which location information obtained from one or more devices or objects associated with the user is provided to at least one application or service; and
controlling the manner in which location information obtained from one or more devices or objects that are not associated with the user is provided to at least one application or service.

13. A system comprising:
a user interface configured to obtain a location tracking privacy policy associated with a user, wherein the location tracking privacy policy includes a location reporting methodology and one or more enforcement conditions;
a location tracking system interface configured to obtain location information associated with the user; and
a visibility manager configured to determine whether the enforcement condition(s) have been satisfied and to control the manner in which the location information associated with the user is provided to at least one application or service in accordance with the location reporting methodology responsive to determining that the enforcement condition(s) have been satisfied.

14. The system of claim 13, wherein the visibility manager is configured to control the manner in which the location information associated with the user is provided to the at least one application or service in accordance with the location reporting methodology by prohibiting the location information associated with the user from being provided to the at least one application or service.

15. The system of claim 13, wherein the visibility manager is configured to control the manner in which the location information associated with the user is provided to the at least one application or service in accordance with the location reporting methodology by modifying the location information associated with the user.

16. The system of claim 13, wherein the visibility manager is configured to control the manner in which the location information associated with the user is provided to the at least one application or service in accordance with the location reporting methodology by altering a granularity of the location information associated with the user.

17. The system of claim 13, wherein the visibility manager is configured to determine whether the enforcement condition(s) have been satisfied by determining whether a particular person or category of persons is intended to receive the location information associated with the user.

18. The system of claim 17, wherein the visibility manager is configured to determine whether a particular person is intended to receive the location information associated with the user by determining whether a person having a particular degree of social connectedness with the user is intended to receive the location information associated with the user.

19. The system of claim 17, wherein the visibility manager is configured to determine whether a particular person is intended to receive the location information associated with the user by determining whether a person having a particular type of social relationship with the user is intended to receive the location information associated with the user.

20. The system of claim 13, wherein the visibility manager is configured to determine whether the enforcement condition(s) have been satisfied by determining whether the user is engaging in an activity associated with a particular topic.

21. The system of claim 13, wherein the visibility manager is configured to determine whether the enforcement condition(s) have been satisfied by determining whether a topical nexus exists between the user and an intended recipient of the location information about the user.

22. The system of claim 13, wherein the visibility manager is configured to determine whether the enforcement condition(s) have been satisfied by determining whether a current time matches a specified time or is within a specified time period.

23. The system of claim 13, wherein the visibility manager is configured to determine whether the enforcement condition(s) have been satisfied by determining whether a location of the user matches a particular location or is within a particular area.

24. The system of claim 13, wherein the visibility manager is configure to control the manner in which the location information associated with the user is provided to at least one application or service in accordance with the location reporting methodology by controlling the manner in which location information obtained from one or more devices or objects associated with the user is provided to at least one application or service and by controlling the manner in which location information obtained from one or more devices or objects that are not associated with the user is provided to at least one application or service.

25. A method for enabling a user to modify logged location information associated with the user, comprising:
receiving a first request to access location information associated with the user that is stored in one or more location information logs;
providing access to the location information associated with the user responsive to receiving the first request;
receiving a second request to modify the location information associated with the user; and
modifying the location information associated with the user responsive to receiving the second request.

26. The method of claim 25, wherein modifying the location information associated with the user comprises deleting the location information associated with the user.

27. The method of claim 25, wherein modifying the location information associated with the user comprises changing the content of the location information.
